(19) United States
(12) Patent Application Publication
(10) Pub. No.: US 2016/0370499 A1
(43) Pub. Date: Dec. 22, 2016

(54) Determining Geomechanics Completion Quality

(71) Applicant: SCHLUMBERGER TECHNOLOGY CORPORATION, Sugar Land, TX (US)

(72) Inventors: Thomas Berard, Richmond (GB); Jean Desroches, Saint Maime (FR)

(21) Appl. No.: 14/903,587

(22) PCT Filed: Jul. 8, 2014
(86) PCT No.: PCT/US14/45811

§ 371 Date: Jan. 7, 2016

Related U.S. Application Data
(60) Provisional application No. 61/843,589, filed on Jul. 8, 2013.

(51) Int. Cl. G01V 99/00; E21B 43/26

(52) U.S. Cl. CPC G01V 99/005; E21B 43/26

(57) ABSTRACT

Systems, methods, and computer-readable media for processing geomechanical data. The method may include receiving a three-dimensional model of a subterranean volume that includes a reservoir, and determining, using a processor, one or more hydraulic fracture performance attributes of the subterranean volume based in part on the model. The method may also include determining a completion quality for one or more locations in the subterranean volume based at least in part on the one or more hydraulic fracture performance attributes.

### CROSS-REFERENCE TO RELATED APPLICATIONS

This application claims priority to U.S. Provisional Patent Application Ser. No. 61/843,589, which was filed on Jul. 8, 2013. The entirety of this provisional application is incorporated herein by reference.

### BACKGROUND

Hydraulic fracturing generally includes the process of pumping fracturing fluid into a wellbore to create sufficient downhole pressure to crack or fracture a subterranean formation. This allows proppants to be injected into the formation, thereby creating a plane of high-permeability sand through which fluids, such as hydrocarbons, may flow. After hydraulic pressure is removed, the proppants may remain in place and prop open the fracture to enhance the flow of fluids from the formation and into the wellbore.

Hydraulic fracture models are employed to forecast (e.g., by simulation) the fracture properties that are likely to be exhibited under various fracturing conditions. The modeling and simulation processes may employ geomechanical data, e.g., as collected from the field. However, such geomechanical input to the hydraulic fracturing models may be derived from one-dimensional mechanical earth modeling, e.g., based on data established along a trajectory of a well. To use this data, the hydraulic fracturing model includes assumptions, such as horizontal layering, laterally-uniform properties, isotropic or linear, elastic behavior, no faults or fractures, and no coupling between layers.

These assumptions may lead to adequate approximations in many cases; however, in some cases, these assumptions may be inaccurate, leading to an unknown uncertainty value in the model. Moreover, to the extent that three- or four-dimensional geomechanical data may be available, interpretation of this data is not fully achieved.

There is a need, therefore, for systems and methods for interpretation of mechanical earth model data, e.g., to establish completion quality.

### SUMMARY

The above deficiencies and other problems associated with processing of collected data are reduced or eliminated by the disclosed methods and systems.

Embodiments of the disclosure may provide a method for processing geomechanical data. The method may include receiving a three-dimensional model of a subterranean volume that includes a reservoir, and determining, using a processor, one or more hydraulic fracture performance attributes of the subterranean volume based in part on the model. The method may also include determining a completion quality for one or more locations in the subterranean volume based at least in part on the one or more hydraulic fracture performance attributes.

In an embodiment, the method may include displaying data representing the one or more hydraulic fracture performance attributes in the model, displaying data representing the completion quality in the model, or both.

In an embodiment, the one or more locations include one or more locations for positioning a well, or one or more locations along a well, or one or more sub-volumes in the subterranean domain, or a combination thereof. In an embodiment, the method further includes comparing respective locations in the one or more locations based at least in part on respective determined completion qualities.

In an embodiment, the method further includes receiving generic well data for a plurality of locations in the subterranean volume, and determining the one or more hydraulic fracture performance attributes includes using the generic well data.

In an embodiment, the model includes a geo-cellular grid including cells, and the method further includes calculating the generic well data based at least partially on one or more well trajectories that satisfy a physical criterion for one or more of the cells.

In an embodiment, the three-dimensional model includes a geo-cellular grid including cells, and determining the one or more hydraulic fracture performance attributes includes, for one or more of the cells, determining a principal stress direction that is closest to a vertical or to a normal to a bedding.

In an embodiment, the three-dimensional model includes a geo-cellular grid including cells, and determining the one or more hydraulic fracture performance attributes includes determining a stress regime and a stress ellipticity factor for one or more of the cells.

In an embodiment, the three-dimensional model includes a geo-cellular grid comprising cells, and wherein determining the one or more hydraulic fracture performance attributes includes determining a stress anisotropy for one or more of the cells.

In an embodiment, the three-dimensional model includes a geo-cellular grid including cells, and determining the one or more hydraulic fracture performance attributes includes, for one or more of the cells, determining a fracture initiation pressure, a fracture pressure, a fracture initiation pressure gradient, a fracture pressure gradient, a net pressure, a net pressure gradient, or a combination thereof.

In an embodiment, the three-dimensional model includes a geo-cellular grid including layers, and determining the one or more hydraulic fracture performance attributes includes identifying one or more stress barriers between layers of the model that exceed a predetermined threshold.

In an embodiment, the three-dimensional model includes a geo-cellular grid including cells, and determining the one or more hydraulic fracture performance attributes includes defining an operator that intersects a plurality of the cells such that the operator is normal to a direction of minimum horizontal stress in the plurality of cells, and determining the one or more hydraulic fracture performance attributes for the plurality of cells intersected by the operator.

In an embodiment, the three-dimensional model includes a geo-cellular grid including cells, and determining the one or more hydraulic fracture performance attributes includes determining a misalignment angle between a hydraulic fracture at the borehole-wall and the well axis for one or more of the cells, determining a difference between two tangential principal stress magnitudes in a near-well region of the model, and determining whether the misalignment angle is defined based at least in part on the difference between the two tangential principal stress magnitudes.

In an embodiment, the three-dimensional model includes a geo-cellular grid including cells, and determining the one or more hydraulic fracture performance attributes includes determining a near-well stress field and a far-well stress field, calculating, for one or more of the cells, a rotation angle between a normal to a fracture plane at a borehole-wall and a direction of a least-compressive principal stress that would exist in the absence of a well-induced stress perturbation, and determining a fracture reorientation angle between the near-well and far-well regions using the rotation angle.

In an embodiment, the three-dimensional model includes a geo-cellular grid including cells, and determining the one or more hydraulic fracture performance attributes includes determining a stress property and an elastic property along one or more pillars of the cells, performing a hydraulic fracture modeling based at least in part on the stress and elastic properties, and determining a first boundary to be breached and the bottom-hole pressure, or net pressure, or both at a breach point.

In an embodiment, the method further includes receiving a result of a hydraulic fracture model, and calibrating the one or more hydraulic fracture performance attributes based at least in part on the result of the hydraulic fracture model.

In an embodiment, determining the one or more hydraulic fracture performance attributes includes determining one or more attributes selected from the group consisting of: a verticality of a principal stress direction, stress regime, stress anisotropy, plane strain Young's modulus, fracture initiation pressure, fracture pressure, net pressure, a stress barrier, a virtual fracture curtain, a fracture misalignment angle, a fracture re-orientation between a near-well region and a far-well region, a fracture height, and a fracture width.

Embodiments of the disclosure may also provide a computing system including one or more processors, and a memory system including one or more compute-readable media storing instructions thereon that, when executed by the one or more processors, are configured to cause the computing system to perform operations. The operations may include receiving a three-dimensional model of a subterranean volume that includes a reservoir, and determining one or more hydraulic fracture performance attributes of the subterranean volume based in part on the model. The operations may also include determining a completion quality for one or more locations in the subterranean volume based at least in part on the one or more hydraulic fracture performance attributes.

In accordance with some embodiments, a computer-readable storage medium is provided, the medium having a set of one or more programs including instructions that when executed by a computing system cause the computing system to receive a three-dimensional model of a subterranean volume that includes a reservoir, and determine one or more hydraulic fracture performance attributes of the subterranean volume based in part on the model. The instructions may also cause the computing system to determine a completion quality for one or more locations in the subterranean volume based at least in part on the one or more hydraulic fracture performance attributes.

In accordance with some embodiments, a computing system is provided that includes at least one processor, at least one memory, and one or more programs stored in the at least one memory. The computing system further includes means for receiving a three-dimensional model of a subterranean volume that includes a reservoir, and means for determining one or more hydraulic fracture performance attributes of the subterranean volume based in part on the model. The system may also include means for determining a completion quality for one or more locations in the subterranean volume based at least in part on the one or more hydraulic fracture performance attributes.

Thus, the computing systems and methods disclosed herein are more effective methods for processing collected data that may, for example, correspond to a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for processing geomechanical data, according to an embodiment.

FIG. 2 illustrates a flowchart of a method for processing geomechanical data, according to an embodiment.

FIG. 3A illustrates a flowchart of a method for calculating a verticality of a principal stress direction, according to an embodiment.

FIG. 3B illustrates a perspective view of a display of data representing the verticality of the principal stress direction, according to an embodiment.

FIG. 4 illustrates a flowchart of a method for determining a stress regime, according to an embodiment.

FIG. 5 illustrates a flowchart of a method for determining a stress anisotropy of a subterranean volume, according to an embodiment.

FIG. 6 illustrates a flowchart of a method for determining plane strain moduli values for the subterranean volume, according to an embodiment.

FIG. 7 illustrates a flowchart of a method of determining fracture pressure, fracture initiation pressure, net pressure, and gradients thereof, according to an embodiment.

FIG. 8A illustrates a flowchart of a method for calculating stress barriers, according to an embodiment.

FIG. 8B illustrates a conceptual view of a display of data representing stress barriers in a three-dimensional, subterranean volume, according to an embodiment.

FIG. 9 illustrates a flowchart of a method for determining a virtual fracture curtain, according to an embodiment.

FIG. 10A illustrates a flowchart of a method for determining stress misalignment at a borehole-wall, according to an embodiment.

FIGS. 10B and 10C illustrate conceptual views of a portion of a well, with the angles representing the two tangential principal stresses and fracture orientation at the borehole-wall, according to an embodiment.

FIG. 11 illustrates a flowchart of a method for determining a fracture re-orientation, according to an embodiment.

FIG. 12 illustrates a flowchart of a method for determining fracture geometry such as height and width, according to an embodiment.

FIGS. 13A-D illustrate a flowchart of a method for processing geomechanical data, according to an embodiment.

FIG. 14 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

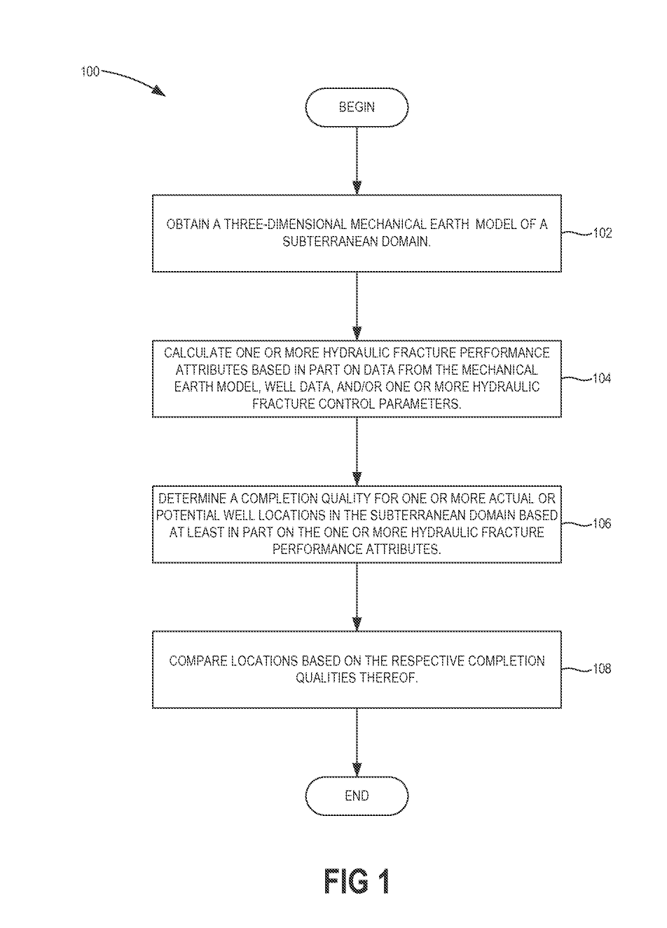

FIG. 1 illustrates a flowchart of a method 100 for processing geomechanical data, according to an embodiment. The method 100 may begin by obtaining a three-dimensional mechanical earth model (MEM) of a subterranean volume or domain, as at 102. In some embodiments, the MEM may be constructed as part of the method 100, e.g., using data collected from the field, such as core samples, well-logs, seismic data, other geologic data, etc. In other embodiments, the MEM may be constructed a priori and may be received as part of the method 100.

The method 100 may also include calculating one or more hydraulic fracture performance attributes based in part on data, in three-dimensions, from the MEM, on well data, and/or one or more hydraulic control parameters, as at 104. The one or more hydraulic fracture control parameters may, in some embodiments, be user-specified. Additionally or instead, the one or more hydraulic fracture control parameters may be established in the model. Examples of such hydraulic fracture control parameters include maximum bottom-hole pressure, well location, well trajectory, pore fluid pressure, tensile strength, poro-elastic properties, pressure communication between the well and the formation, the presence or absence of defects in a formation, the size and orientation thereof (if present), fluid rheology, pressurization rates, and others.

The hydraulic fracture performance attributes may be representative of fracturing performance as well as risk, and may be derived from the three-dimensional MEM data (e.g., on a cell-by-cell basis). Hydraulic fracture “performance” may refer, in some embodiments, to fracture geometry and placement, proppant volume and placement and/or to production totals, rates, or a combination thereof. More particularly, this term may refer to the difference between the expected proppant placement and the actual proppant placement. For example, less than expected proppant may result in over-purchasing and deployment of proppant, and may result in additional well cleaning operations and less than expected production performance. Further, the “performance” may refer to the cumulative amount of hydrocarbons produced over a period of time, an instantaneous rate of production, or similar production metrics.

Hydraulic fracture risk, which may also be represented by the hydraulic fracture performance attributes, refers to the consequences (likelihood and severity, for example) associated with poor performance. Such consequences may include material costs, equipment costs, time, reputation, etc.

Examples of hydraulic fracturing performance attributes, which are described in greater detail below, include verticality of a principal stress direction, stress regime, stress anisotropy, plane strain Young's modulus, fracture initiation and fracture pressure (and/or gradients thereof), upward and downward stress barriers, virtual fracture curtains, fracture geometry, and proxies for near-well tortuosity (e.g., misalignment at the borehole-wall and fracture re-orientation between the near-well and far-well regions). It will be appreciated, however, that this is not to be considered an exhaustive list, but merely a few examples among many hydraulic fracture performance attributes that may be employed consistent with present disclosure. The hydraulic fracture performance attributes may be one-dimensional, as along a wellbore trajectory, two dimensional, as along a surface map, or three-dimensional, as in a volume cube.

Furthermore, in calculating any of hydraulic fracture attributes, well data may be employed. The well data received may be representative of data from an actual or a planned wellbore, and may include locations, trajectory, etc. However, at least some of the well data may be “generic,” rather than actual. For example, actual well data may include specific locations in the modeled, subterranean domain. Generic wellbore data may fix a wellbore trajectory, such as vertical, lateral, or an angle therebetween, and may include wellbores placed at any position in the domain. Further, in some embodiments, the generic wellbores may be defined according to local (e.g., to a cell in a grid) criteria, such as following least-compressive stress directions. The use of generic wellbores may provide an approximation that allows for the calculation of the hydraulic fracture performance attributes at multiple locations, e.g., throughout an entire, modeled subterranean volume. In some embodiments, actual well data may be employed in addition to generic wellbore data.

It will be appreciated that a convention is employed herein that assigns a positive value to a compressive stress magnitude, rather than a negative value. Accordingly, a stress magnitude that is greater, according to the present disclosure, is more compressive, while a stress with a lower magnitude, is less compressive (and/or more tensile).

Additionally, in calculating one or more of the hydraulic fracture performance attributes, near and/or far-well stress fields may be calculated. A near-well stress field may be located around a well and, for example, extend outward therefrom by from about one to about five times the well diameter from the well. In other embodiments, other such wellbore diameter multipliers may be employed in determining the location of the “near-well” stress field. A “far-well” stress field may be a stress-field that is not substantially, or at all, affected by the presence of a wellbore. Generally, a far-well stress field may be a calculated at a distance of at least about five wellbore diameters away from the wellbore, although other multipliers (e.g., about six, about seven, about eight, about nine, about 10, about 15, etc.) may be employed in selecting a far-well region for calculating a far-well stress field.

The method 100 may then proceed to determining a completion quality for one or more actual or potential locations in the subterranean domain based at least in part on the one or more hydraulic fracture performance attributes, as at 106. The locations may be well locations, e.g., where a well may be located in the subterranean volume. The locations may also or instead refer to locations along a well, e.g., to determine depth intervals or the like in a well where treatment may be employed. The location may also be sub-volumes within the subterranean domain. Such a sub-volume may be defined according to the stratigraphy or the lithology or any other rock properties. A sub-volume may also be or include a structural element of the domain, such as a fault-bounded compartment. Completion quality may refer to the expected performance, as defined above, of a well treatment operation at a particular location, whether at a location for the well in the subterranean volume, or a location along a planned or actual well.

Moreover, completion quality may be an index or a rank. For example, a value may be calculated for the completion quality for a well trajectory of the subterranean domain, two-dimensional map (e.g., of the surface or at a particular depth or layer of the subterranean domain), or a three-dimensional volume of a subterranean domain. The value may be compared with other values of the subterranean domain, so as to give a score or rank in relation to other areas of the subterranean volume, or may be provided without such comparison.

The completion quality may be determined based on one of the hydraulic fracture performance attributes. In another embodiment, the completion quality may be determined as a composite of a plurality of hydraulic fracture performance attributes, which may be normalized, weighted, or otherwise adjusted, e.g., according to user preferences, geological factors, mechanical factors, etc. The combination of available hydraulic fracture performance attributes into a completion quality score, rank, screening, etc., may serve to represent the performance and risk associated with treatment and/or production at a given location in the subterranean volume or along a well.

The method 100 may also include comparing locations based on the respective completion qualities at these locations, as at 108. In some embodiments, color-coded, gray-scale, or other types of maps of the completion quality and/or one or more of the hydraulic fracture performance attributes may be displayed. Based on such displays and/or other data, whether qualitatively or quantitatively, a ranking of locations may be developed. Moreover, the completion quality data may be employed to screen out locations with low completion-quality scores, either objectively or in relation to other locations.

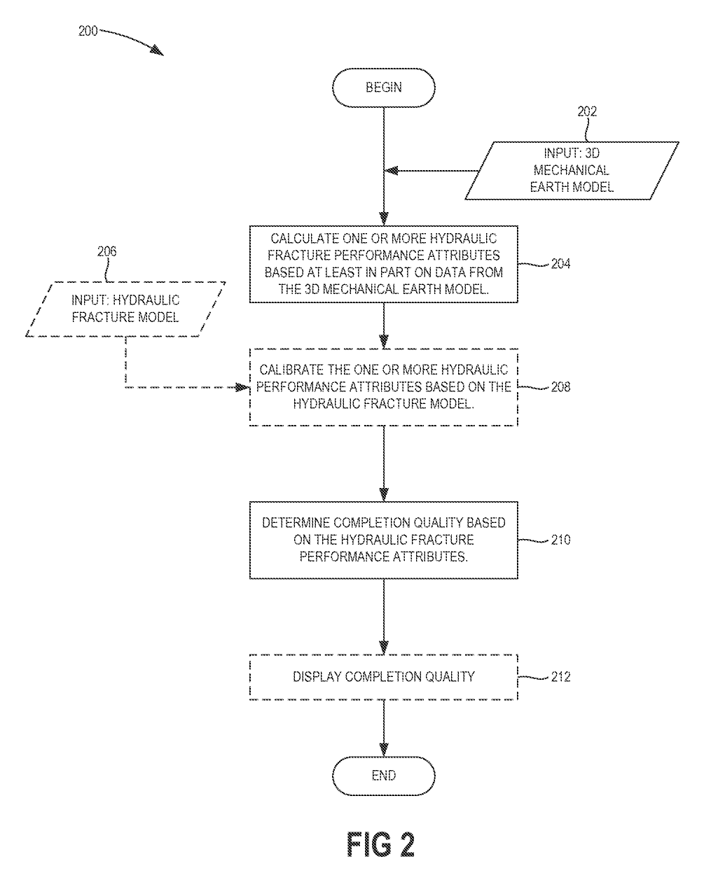

FIG. 2 illustrates a flowchart of a method 200 for processing geomechanical data, according to an embodiment. The method 200 may begin by receiving, as input, a three-dimensional, mechanical earth model (MEM), as at 202. It will be appreciated that the three-dimensional MEM may also include a time dimension. The resulting four-dimensional MEM, however, still includes three dimensions, in addition to the fourth, time, dimension and is thus considered to be within the scope of a “three-dimensional” model, as used herein. The MEM may provide a representation, e.g., in a software application, of a subterranean volume. The subterranean volume may contain one or more porous media, such as rock, and the MEM may contain data representing areas, e.g., as discrete elements such as pixels, voxels, grid meshes, etc. (hereinafter, referred to as “cells”). The MEM may also include material properties for the medium, e.g., with each cell including or otherwise being associated with data representing the material properties of the volume of the medium associated with the cells. Such material properties may include, for example, poro-elastic and strength properties. The MEM may also include pore fluid pressures, temperatures, saturations, principal stress directions and magnitudes, at one or more times (e.g., when time-dependent simulation results are available).

The method 200 may include calculating one or more hydraulic fracture performance attributes based at least in part on data from the three-dimensional MEM, as at 204. Various types of hydraulic fracture performance attributes may be calculated; for example, one or more of those described above with reference to method 100 and FIG. 1 may be calculated.

In some embodiments, data from a hydraulic fracture model may be received, as at 206. In another embodiment, data derived from measurements in the field (e.g., “field data”) may be received instead of or in addition to the hydraulic fracture model. The one or more hydraulic fracture performance attributes may be calibrated based on the data received at 206, e.g. hydraulic fracture model and/or field data, as at 208. In general, hydraulic fracture models may receive characteristics for a subsurface volume (e.g., from a mechanical earth model) and may perform simulations of hydraulic fracturing operations, e.g., the formation of fractures in the subterranean volume. Moreover, the hydraulic fracture models may include field data measurements. The behavior of the hydraulic fracture model, e.g., the way in which the hydraulic fractures grow, may thus be related to the hydraulic fracture performance attributes. Accordingly, observations may be drawn as to the accuracy of the hydraulic fracture performance attributes, based on the hydraulic fracture model. For example, in regions of the subterranean volume where one or more hydraulic fracture performance attributes are inconsistent with the results of the hydraulic fracture model simulations, the hydraulic fracture performance attributes may be considered unreliable. Similarly, the hydraulic fracture performance attributes may be confirmed where hydraulic fractures in the hydraulic fracture model behave as expected from the hydraulic fracture performance attributes.

The method 200 may then proceed to determining the completion quality based on the hydraulic fracture performance attributes, as at 210. The completion quality may be calculated along a well trajectory, e.g., in one dimension. The completion quality may also or instead be calculated for a two-dimensional surface of the subterranean volume (e.g., the earth's surface or a horizontal or otherwise oriented subterranean layer). The completion quality may also or instead by calculated for a three-dimensional volume or “cube,” e.g., across all of or a region of the subterranean volume. Accordingly, the method 200 may receive, as input, a three (or more)-dimensional MEM, and may output a one, two, or three-dimensional completion quality.

In some embodiments, the completion quality may be displayed, as at 212. For example, completion quality values may be associated with a spectrum of colors or a gray-scale which may provide visual insight into “sweet spots” where the likelihood of successful stimulation of a reservoir and/or production from a wellbore is high. In other embodiments, numerical representations, gradients, or other representations may be rendered.

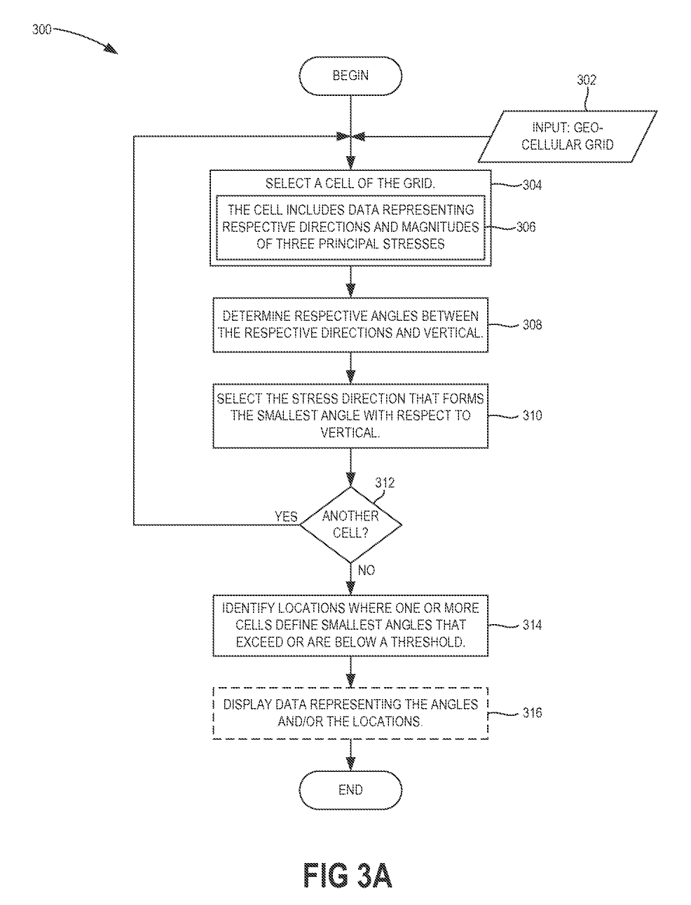

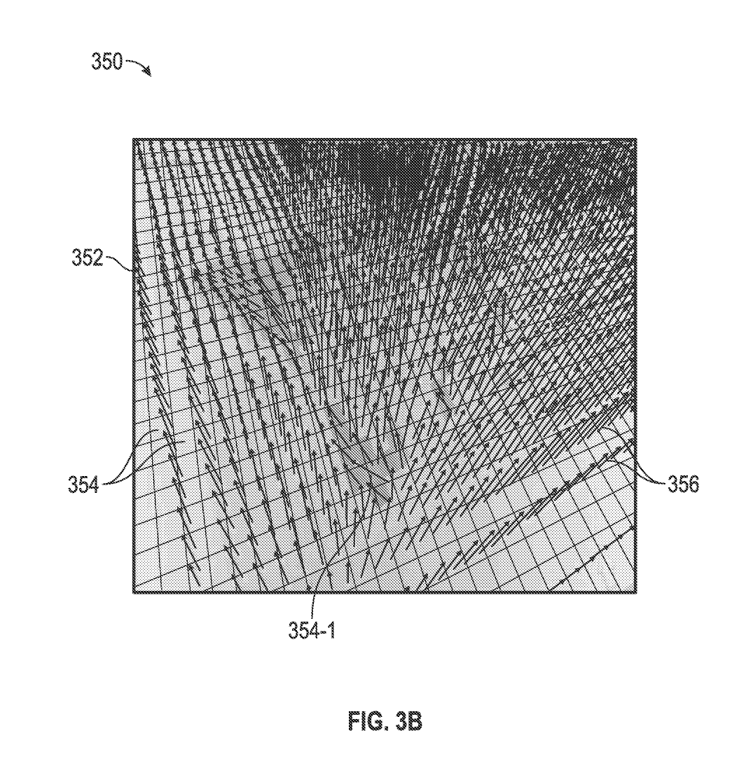

FIG. 3A illustrates a flowchart of a method 300 for calculating a verticality of a principal stress direction, according to an embodiment. Verticality of the principal stress may be a hydraulic fracture performance attribute, which may be used in either or both of methods 100 and 200. The method 300 may receive a three-dimensional, geo-cellular grid as input, as at 302. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid. For example, the cells may include data representing a magnitude and an orientation of three principal stresses in the respective regions. The three principal stresses are generally denoted in mechanics as σ₁, σ₂, σ₃ and are calculated as the three stresses normal to the three principal planes to which the corresponding stress vector is perpendicular.

The method 300 may include selecting a cell of the grid, as at 304. The selected cell may include data representing respective directions and magnitudes of the three principal stresses, as indicated at 306. More particularly, for example, the cell may include the directions and magnitudes of the three principal stresses incident on the medium represented by the cell in the geo-cellular grid of the subterranean domain.

The method 300 may then proceed to determining respective angles between the respective stress directions and a vertical, as at 308. The vertical may be defined along a radial line that extends from the center of the Earth. Accordingly, determining at 308 may proceed by considering the three principal stress directions in turn or at the same time and measuring their trajectory angle from vertical. The method 300 may then include determining the smallest angle from vertical among the three principal stress directions, as at 310. In another embodiment, the angles can be determined relative to the bedding orientation, e.g., instead of the true vertical and/or horizontal.

The method 300 may then include determining whether to select another cell, as at 312. If another cell is to be selected, the method 300 may return to selecting a cell of the grid at 304. If not, the method 300 may proceed to block 314. In some embodiments, the method 300 may include considering one, some (e.g., a predetermined subset), or all of the cells of the grid received at 302.

At block 314, the method 300 may include identifying a location where one or more cells define smallest angles that exceed or are below a threshold. The smallest angles may be the minimum angles determined at 308 between the principal stress directions and the vertical or between the principal stress directions and the bedding. The threshold may be predetermined, user-specified, set according to mechanical or geological factors, and/or may be established based on the mean, standard deviation, etc. of the determined smallest angle measurements (e.g., to indicate outliers).

The method 300 may also, in some cases, include displaying data representing the smallest angle measurements, the locations where the smallest angles are above or below the threshold, or both, as at 316. For example, displaying at 316 may include highlighting the identified locations where the smallest angles exceed or fall below the threshold, display a color-coded display of some or all of the angle values, or may provide any other suitable display based at least in part on the verticality and/or on the off-bedding tilt. In some embodiments, data representing the verticality and/or the off-bedding tilt may be combined with other data, e.g., other hydraulic fracture performance attributes, to derive completion quality values for the subterranean volume.

FIG. 3B illustrates a perspective view of a display 350 of data representing the verticality of the principal stress direction, according to an embodiment. The display 350 may include a three-dimensional, geo-cellular grid 352, which may include cells 354 and arrows 356 in each cell 354, with the arrows 356 representing a principal stress direction of the cell 354. In particular, for example, the arrows 356 may represent the principal stress direction that is closest to vertical, e.g., as determined at block 308 of FIG. 3A. The arrows 356 may be color-coded, weighted, or otherwise highlighted to draw attention to the cells 354 with a verticality that exceeds one or more thresholds, is a statistical anomaly, etc. Similarly, the cells 354 themselves may be color-coded or otherwise highlighted, e.g., as shown for cell 354-1, to provide a similar effect.

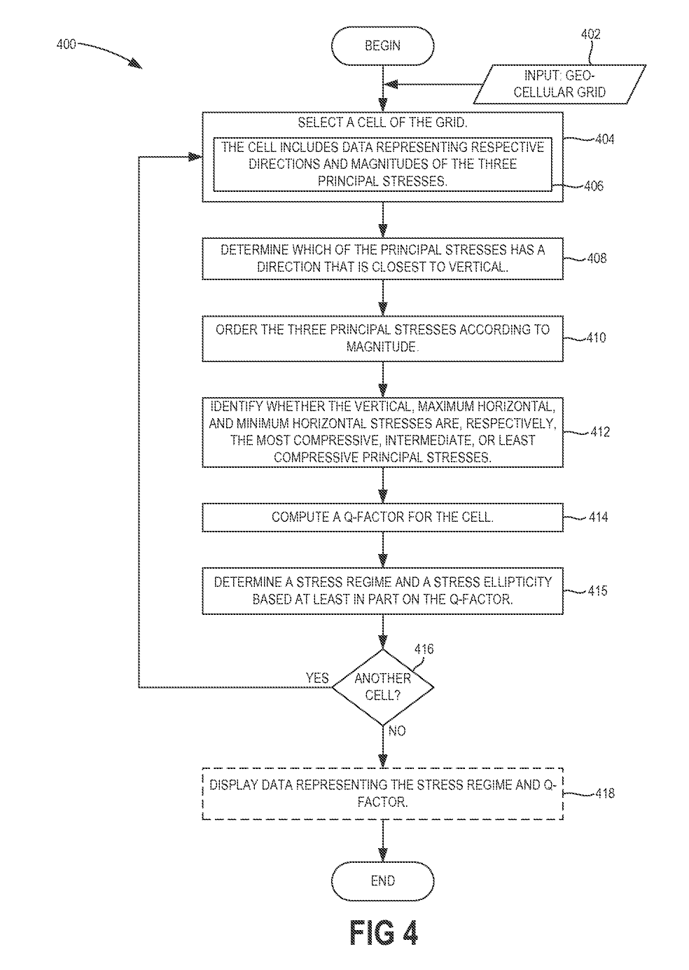

FIG. 4 illustrates a flowchart of a method 400 for determining a stress regime, according to an embodiment. The stress regime may be a hydraulic fracture performance attribute, which may be employed to determine completion quality. Generally, stress regime may fall into one of three faulting categories: normal, strike-slip, and thrust. The faulting category may determine the appropriate equation for calculating the Q-value, which may be a representation of stress ellipticity factor; accordingly, the stress regime may be determined based upon the Q-factor. In particular, according to an embodiment, a stress ellipticity factor R may be defined according to equation (1):

$$R = \frac{{σ}_{2} - {σ}_{3}}{{σ}_{1} - {σ}_{3}}$$

where σ₁, σ₂, and σ₃ are the most compressive, intermediate, and least-compressive stresses, respectively.

In the illustrated embodiment, the method 400 may receive a three-dimensional, geo-cellular grid, as at 402. The geo-cellular grid may include a plurality of cells that represent discrete regions of the subterranean volume; particularly, in an embodiment, the cells of the grid may include (e.g., as by association in a database, table, etc.) data representing mechanical properties of the medium contained in region of the subterranean volume represented by the cell in the grid.

The method 402 may include selecting a cell of the grid, as at 404. The cell may include data representing respective directions and magnitudes of the three principal stresses, as indicated at 406. The method 400 may then proceed to determining which of the three principal stresses has a direction that is closest to vertical, as at 408. The method 400 may also include ordering the three principal stresses according to their respective magnitudes, as at 410. Further, the method 400 may include identifying whether the vertical, maximum horizontal, and minimum horizontal stresses are, respectively, the most compressive, intermediate, or least compressive principal stresses, in terms of magnitude, as at 412. The method 400 may proceed to computing a Q-factor for the cell, as at 414. Thereafter, in an embodiment, the method 400 may proceed to determining a stress regime and a stress ellipticity factor for the cell based at least in part on the Q-factor, as at 415.

The method 400 may then determine whether to consider another cell of the grid, as at 416. In some embodiments, the method 400 may include considering one, some, or all cells of the grid. If an additional cell is to be considered, the method 400 may return to block 404 and select another cell. On the other hand, if the method 400 determines that there are no more cells to be considered, the method 400 may proceed, in an embodiment, to displaying data representing the stress regime and the Q-factor, e.g., in a color-coded volume or map, as at 418. In another embodiment, the method 400 may omit displaying the stress regime and/or Q-factor data, and such data may be supplied for use in other process and/or for determining, e.g., the completion quality. For example, a location with a thrust stress regime may result in a low completion quality score or ranking.

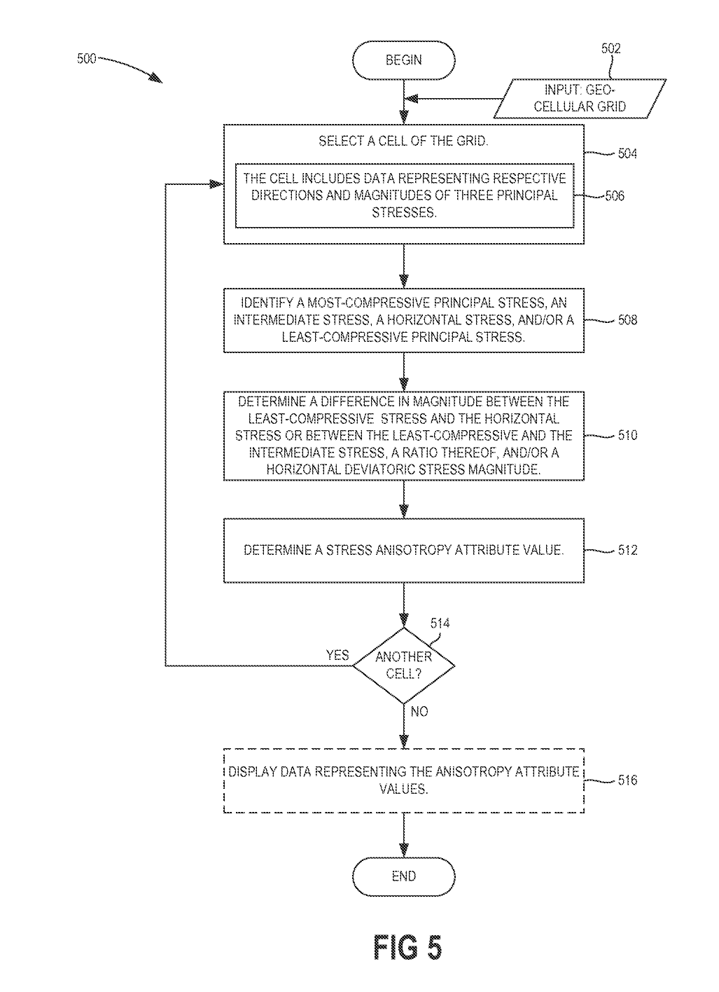

FIG. 5 illustrates a flowchart of a method 500 for determining stress anisotropy of a subterranean volume, according to an embodiment. Stress anisotropy may be a hydraulic fracture performance attribute, which may be employed to calculate the completion quality. Further, the method 500 may include receiving, as input, a three-dimensional, geo-cellular grid, as at 502. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid.

The method 500 may include selecting a cell of the grid, as at 504. The selected cell may include data representing respective directions and magnitudes of the three principal stresses, as indicated at 506. The method 500 may then proceed to identifying the one of the three principal stresses that has the most-compressive principal stress magnitude, and the one of the three-principal stresses that has the least-compressive principal stress magnitude, as at 508. The method 500 may then compare the magnitudes of the most-compressive and least-compressive principal stresses. For example, as illustrated, the method 500 may include determining a difference between the magnitudes of the most-compressive and least-compressive magnitudes, determining a ratio thereof, and/or determining a horizontal deviatoric stress magnitude, as at 510. Deviatoric stress is derived by subtracting the mean of the normal stress components of the stress matrix from each diagonal component thereof.

Based at least in part on the difference, ratio, and/or deviatoric stress, a stress anisotropy attribute value may be determined, as at 512. The value of the anisotropy attribute may be the same as the difference, ratio, or deviatoric stress, as calculated at 510. In another embodiment, the anisotropy attribute value may be derived from the values calculated at 510, for example, based on a combination of the difference, ratio, and/or deviatoric stress, based on the values calculated for neighboring cells, and/or based on statistics (e.g., mean and standard deviation) of other cells of the grid.

The method 500 may then include determining whether there are other cells for calculating a stress anisotropy attribute value, as at 514. In some embodiments, the method 500 may calculate the anisotropy attribute value for one, some, or all of the cells of the grid. In some embodiments, the method 500 may proceed to displaying the stress anisotropy attribute values, e.g., in association with the grid cells, as at 516. For example, the values may be associated with colors or gray-levels, which may be used to highlight cells associated with anisotropy attribute values that exceed a threshold, fall below a threshold, differ from neighboring cells' anisotropy attribute values, etc. In other embodiments, however, the anisotropy attribute values may not be directly displayed, but may be combined with one or more other hydraulic fracture performance attributes to arrive at a completion quality, which then may or may not be displayed visually.

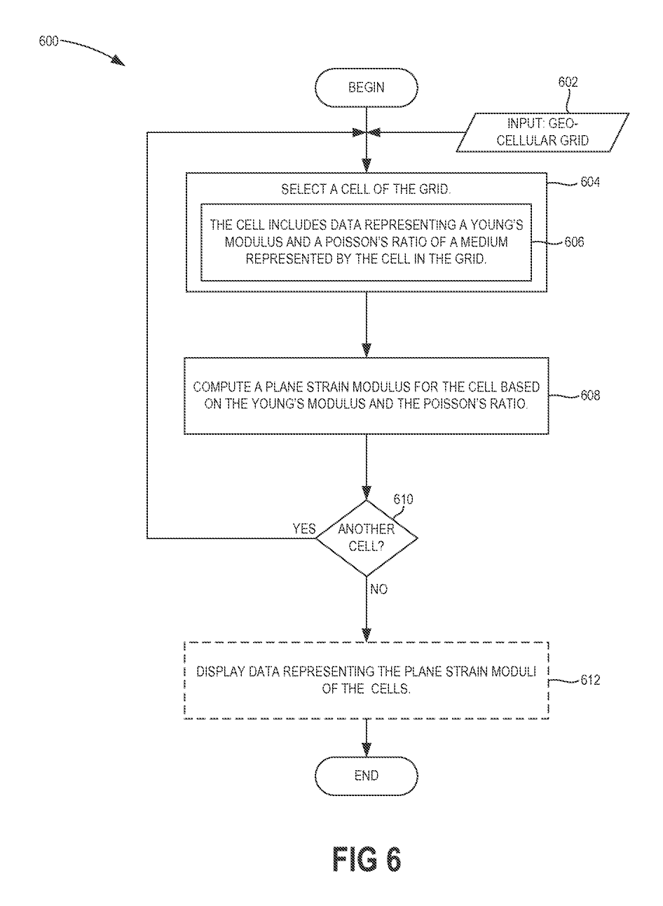

FIG. 6 illustrates a flowchart of a method 600 for determining plane strain moduli for the subterranean volume, according to an embodiment. The plane strain values may be a hydraulic fracture performance attribute, which may be employed to determine a completion quality, as noted above with respect to FIGS. 1 and 2.

The method 600 may include receiving a three-dimensional, geo-cellular grid as an input, as at 602. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid.

The method 600 may also include selecting a cell of the grid, as at 604. In an embodiment, the selected cell may include data representing a Young's modulus value and a Poisson's ratio value of the medium of the region represented by the cell, as indicated at 606. The method 600 may then proceed to computing a plane strain modulus for the cell based on the Young's modulus value and the Poisson's ratio value, as at 608. The plane strain modulus value may be stored in association with the cell, e.g., in a data structure linking a location or identity of the cell with the plane strain modulus value thereof.

The method 600 may also include determining whether the plane strain modulus is to be calculated for additional cells, as at 610. If it is, the method 600 may return to selecting a cell of the grid and repeating the calculations. If not, the method 600 may proceed to displaying data representing the plain strain moduli of the cells, as at 612.

For example, the display may include color-coding or applying a gray-scale to the cells according to the plain strain modulus values. In some embodiments, the cells may be highlighted (e.g., by contrasting color, gray-level, etc.) based on the plane strain exceeding one or more thresholds, based on rank relative to other cells in the subterranean volume, statistics, etc. In other embodiments, the method 600 may not display the plane strain values. Moreover, in some embodiments, the plain strain values may be employed, e.g., in combination with one or more other hydraulic fracture attributes, to determine the completion quality.

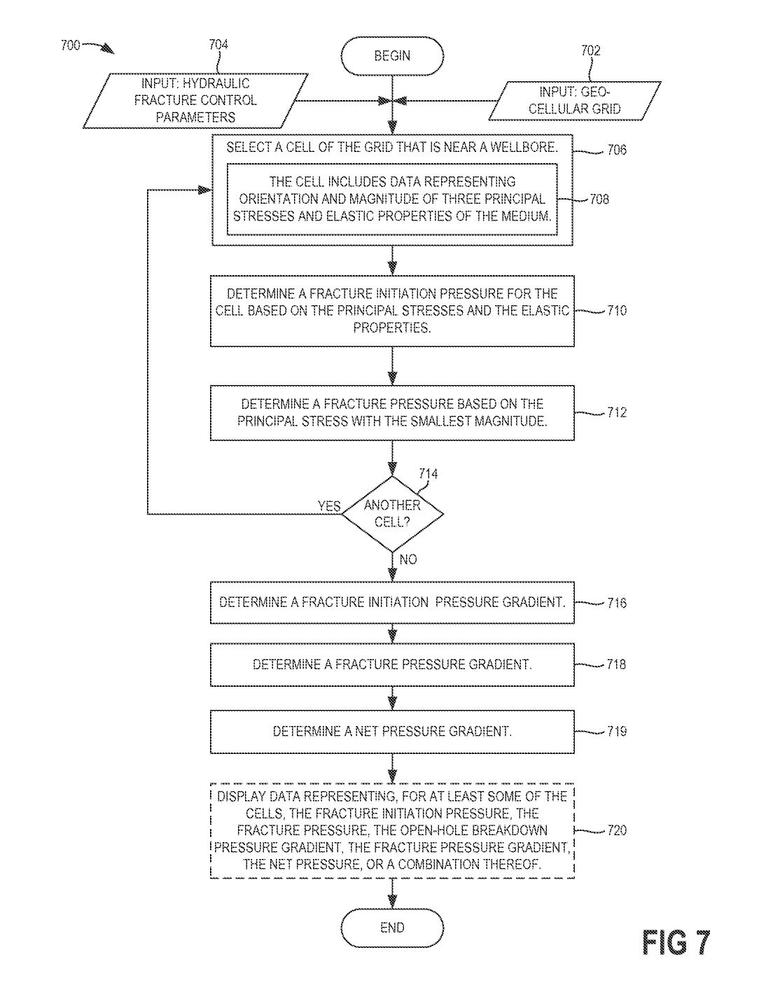

FIG. 7 illustrates a flowchart of a method 700 of determining fracture pressure, fracture initiation pressure, net pressure, and gradients thereof, according to an embodiment. The fracture pressure, initiation pressure, and gradients thereof may be hydraulic fracture performance attributes that may be employed in calculating a completion quality.

The method 700 may include receiving a three-dimensional, geo-cellular grid as input, as at 702. The geo-cellular grid may include a plurality of cells that may represent discrete regions of a subterranean volume. The method 700 may also include receiving one or more hydraulic fracture control parameters as input, as at 704, and well orientation data. In an embodiment, the hydraulic fracture control parameters may include characteristics of the subterranean volume such as the pore fluid pressure, the tensile strength, the fracture toughness, the Biot's poro-elastic coefficient, a coefficient describing the pressure communication between the well and the formation, the presence or absence of preexisting defects and, if present, the size and orientation of the defects, the fluid rheology, and the pressurization rate. The hydraulic fracture control parameters may also include well orientation data.

The method 700 may then proceed to selecting a cell of the grid, e.g., that is near a wellbore, as at 706. As explained above, a cell may be “near” a wellbore if its properties are affected by the stress perturbations caused by the well. Further, the selected cell may include data representing orientation and magnitude of the three principal stresses and elastic properties of the medium, as indicated at 708. The method 700 may then proceed to determining an initiation pressure for the cell based on the principal stresses and the elastic properties, as at 710. Further, the method 700 may include determining a fracture pressure based on the principal stress with the smallest magnitude of the three principal stresses, as at 712.

The method 700 may then proceed to determining whether there are additional cells for which fracture pressure is to be determined, as at 714. In some embodiments, one, some, or all of the cells of the grid may be considered. Accordingly, when it is determined at 714 to consider additional cells, the method 700 may return to selecting a cell and may perform determinations at 710 and 712 for the newly-selected cell.

In some embodiments, when it is determined at 714 that no further cells are to be considered for fracture initiation pressure, the method 700 may proceed to determining fracture initiation based on the fracture initiation pressure of the cells and a true vertical depth of the cells, as at 716. For example, the change in fracture initiation pressure for the cells as a function of vertical depth (e.g., by dividing the fracture initiation pressure by the vertical depth for the cells) may be calculated, so as to yield the gradient. In other embodiments, this determination at 716 may occur prior to determining that no additional cells are to be determined, e.g., after a certain number or subset of cells are considered.

The method 700 may also include determining a fracture pressure gradient based on the fracture pressure of the cells and a true vertical depth of the cells, as at 718. For example, the fracture pressures of the cells may be divided by the true vertical depth of the cells, so as to provide the fracture pressure gradient at 718. The method 700 may also or instead calculate a net pressure and/or net pressure gradient, as at 719. The net pressure may be the fracture pressure plus an amount of pressure that may be employed to propagate the fractures to a predetermined length and/or to push proppants into the fractures.

The method 700 may, in at least some embodiments, include displaying a representation of the initiation pressure, the fracture pressure, the fracture initiation pressure, and/or the fracture pressure gradient for at least some of the cells of the grid, as at 720. For example, the pressures and/or gradients may be color-coded in a visual depiction of the geo-cellular grid. In another embodiment, the pressures and/or gradients may be plotted, e.g., as a function of vertical depth.

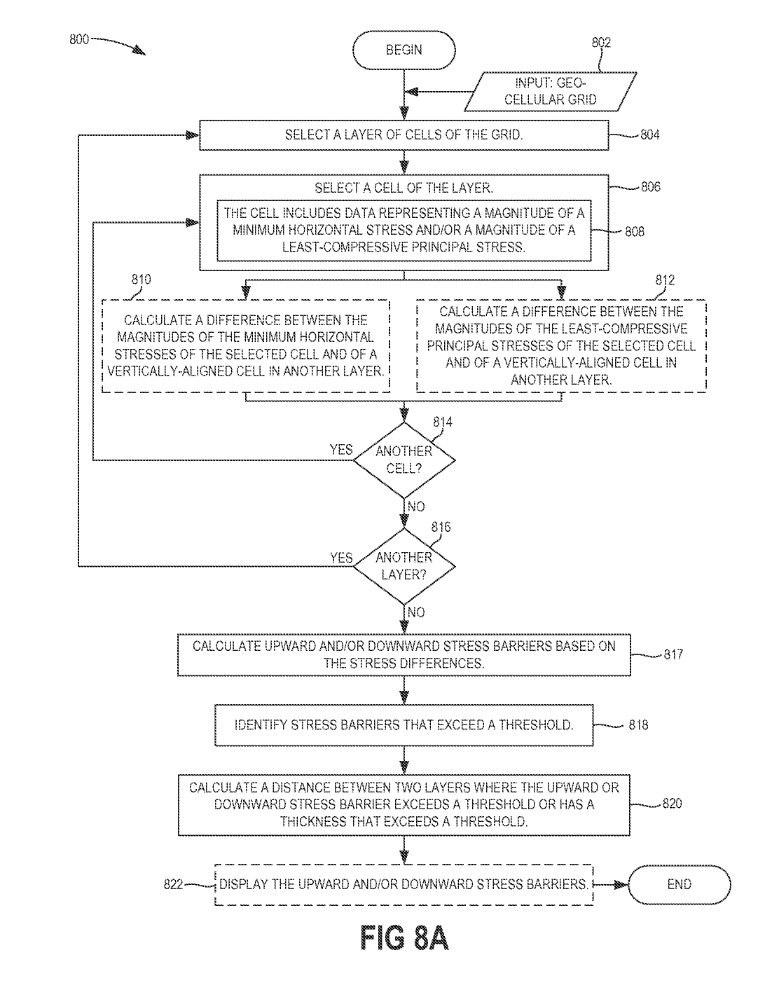

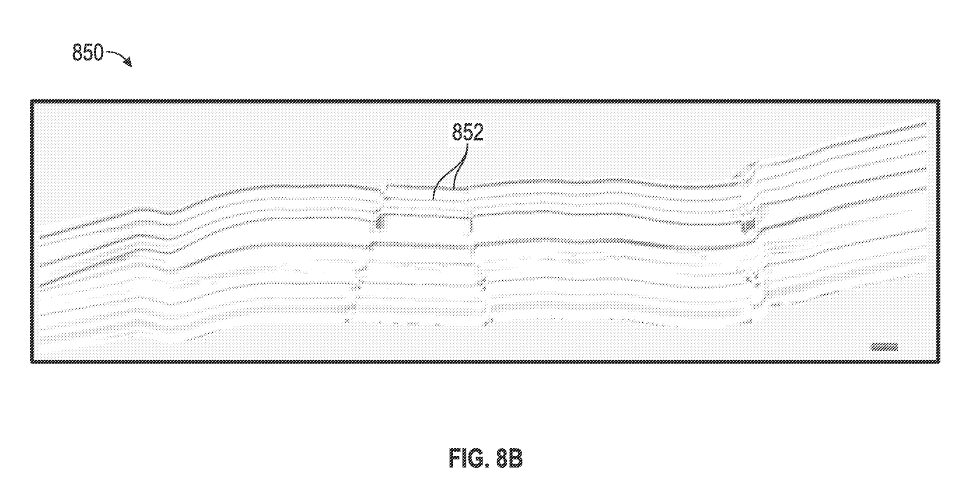

FIG. 8A illustrates a flowchart of a method 800 for calculating upward and/or downward stress barriers, according to an embodiment. The method 800 may include receiving, as input, a three-dimensional, geo-cellular grid, as at 802. The geo-cellular grid may include a plurality of cells that represent discrete regions of a subterranean volume in a mechanical earth model. The cells may be arranged in any suitable manner, such as in a pillar grid. Moreover, the cells may define layers, e.g., according to a stratigraphy of the subterranean volume. The layers may be defined at a depth interval, although the depth interval may vary for a layer, e.g., according to the topography of the layer. Accordingly, the layers may be at least partially superposed or subjacent to one another.

The method 800 may include selecting a layer of the grid, as at 804. The method 800 may also include selecting a cell of the layer, as at 806. The cell that is selected may include data representing a magnitude of a minimum horizontal stress and/or a magnitude of a least-compressive principal stress, as indicated at 808.

In an embodiment, the method 800 may then proceed to calculating a difference between the magnitudes of the minimum horizontal stresses of the selected cell and of a cell of a vertically aligned cell of an adjacent layer, as at 810. This difference may be considered a stress barrier. Moreover, if the vertically-aligned cell is in a layer that is vertically above the selected cell, the stress barrier may be a downward stress barrier. Similarly, if the vertically-aligned cell is in a layer that is vertically below the selected cell, the stress barrier may be an upward stress barrier.

Additionally or instead, the method 800 may include calculating a difference between the magnitudes of the least-compressive principal stresses of the selected cell and of a vertically-aligned cell in an adjacent layer, as at 812. This difference may also be considered a stress barrier, and may be an upward or downward stress barrier, according to the direction of vertical adjacency, as explained above.

The method 800 may then determine whether to consider any additional cells of the currently-selected layer, as at 814. The method 800 may include considering one, some, or all of the cells of the selected layer. If additional layers are to be considered, the method 800 may return to selecting a cell of the layer and performing the calculations at 810 and 812 for the newly-selected cell.

If the determination at 814 is that no additional cells of the layer are to be considered, the method 800 may proceed to determining whether to select another layer, as at 816. If an additional layer is to be selected, the method 800 may return to selecting a layer at 814. The method 800 may include selecting one, some, or all of the layers in the geo-cellular grid.

Otherwise, the method 800 may proceed to calculating upward and/or downward stress barriers based on the stress differences, as at 817. The method 800 may then identify stress barriers that exceed a threshold, as at 820. In some embodiments, the threshold may be user-defined, predetermined, calculated based on mechanical and/or geological factors, or established in any other way. Moreover, the thresholds for upper stress barriers may be the same or different than the thresholds for downward stress barriers. The method 800 may then include calculating a distance between two layers where an upward or downward stress barrier exceeds a threshold or has a thickness that exceeds a threshold, as at 820.

The method 800 may also, in some embodiments, include displaying the upward and/or downward stress barriers that exceed the threshold(s), as at 822. Further, the location of such stress barriers may be employed as a hydraulic fracture performance attribute and used in calculating a completion quality.

FIG. 8B illustrates a conceptual view of a display 850 of data representing stress barriers in a three-dimensional, subterranean volume, according to an embodiment. The subterranean volume may include a plurality of layers, which may not be individually distinguishable, except where highlighted in the display 850, but in other embodiments, the layers may be separated, partitioned, etc. Further, the layers generally stacked, one on top of the other, in a generally vertical direction. It will be appreciated that the layers may pinchout, stop, merge, and/or be offset by faults, etc.

The display 850 may highlight one or more stress barriers 852, which may be represented as layers, or parts thereof, where the calculated stress barrier (as at 817 in FIG. 8A), exceeds a threshold.

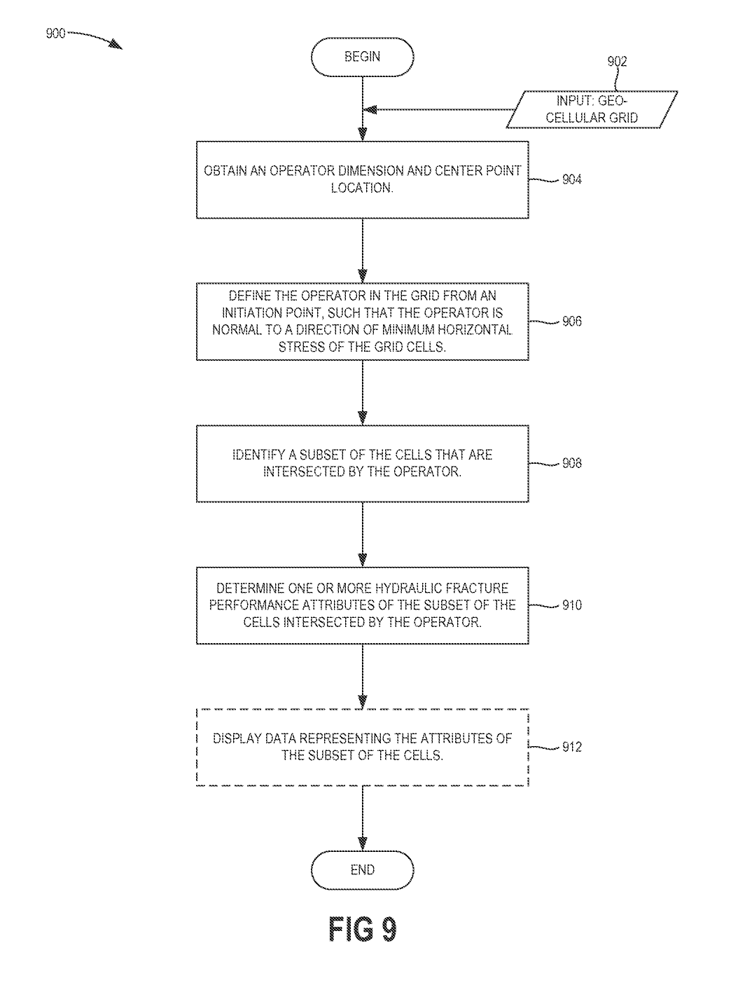

FIG. 9 illustrates a flowchart of a method 900 for determining a virtual fracture curtain, according to an embodiment. The method 900 may include receiving, as input, a three-dimensional, geo-cellular grid, as at 902. The geo-cellular grid may include a plurality of cells that represent discrete regions of a subterranean volume. The cells may also include or otherwise be associated with (e.g., in a database or table) data representing the principal stresses in the subterranean volume at the location of the cells. In particular, the grid cells may include or be associated with data representing the direction of the minimum horizontal stress and/or other mechanical characteristics.

The method 900 may also include obtaining parameters for an operator, such as the center point location and dimension thereof, as at 904. The operator may be square, rectangular, circular, elliptical, or any other shape. Further, the operator may have a center point, and, depending on the shape, one or more dimensions (e.g., radius, major/minor diameter, length, width, etc.). The shape, size, and/or location of the operator may be user-defined, but in other embodiments, may be predetermined and/or set according to mechanical, geological, or other factors.

The operator may be defined in the grid from an initiation point such that the operator is normal to a direction of the minimum horizontal stress of the grid cells that it intersects, as at 906. Accordingly, in some embodiments, the operator may be stretched, twisted, etc., so as to conform to the normality condition.

The method 900 may also include identifying a subset of the cells of the grid that are intersected by the operator, as at 908. Once the operator is defined and the subset of cells cut by the operator is identified, certain grid cell properties of the subset may be determined. Accordingly, the method 900 may include determining one or more hydraulic fracture performance attributes of the subset of the cells intersected by the operator, as at 910. Data representing the hydraulic fracture performance attribute of the subset may, in some embodiments, be displayed, as at 912. The use of the operator and the display of the attributes of the subset may facilitate the visualization and screening of the conditions a hydraulic fracture is expected to experience, e.g., away from the well. In particular, the degree of lateral uniformity of these conditions may be assessed. Certain attributes of the virtual surface itself, such as its tortuosity, may also be assessed. This may also be used to extract data from the identified subset, and condition the data, so as to form input to hydraulic fracture models that accommodate lateral heterogeneity in confining stress and therefore model dissymmetric fractures.

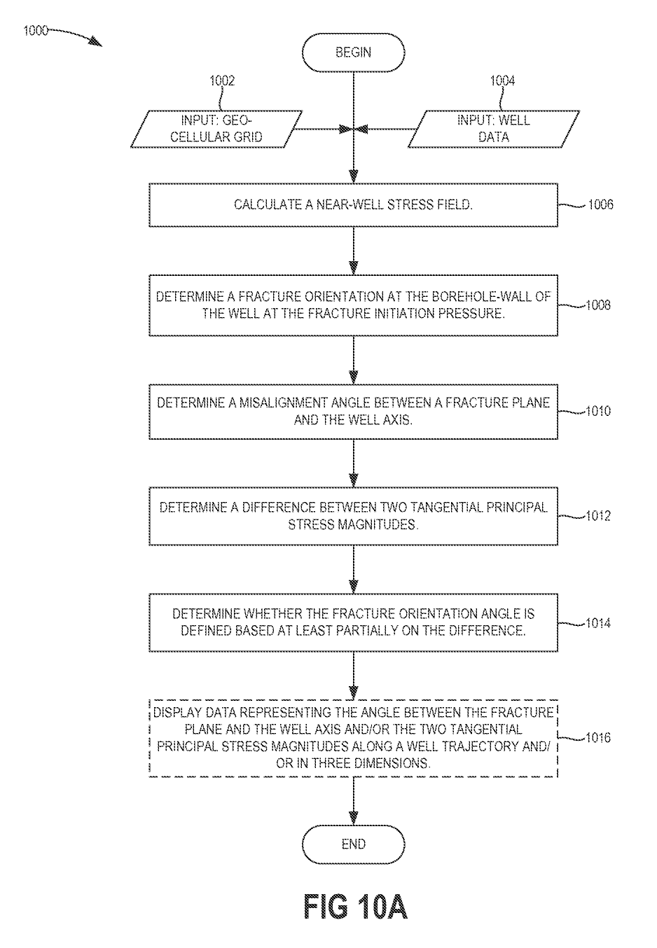

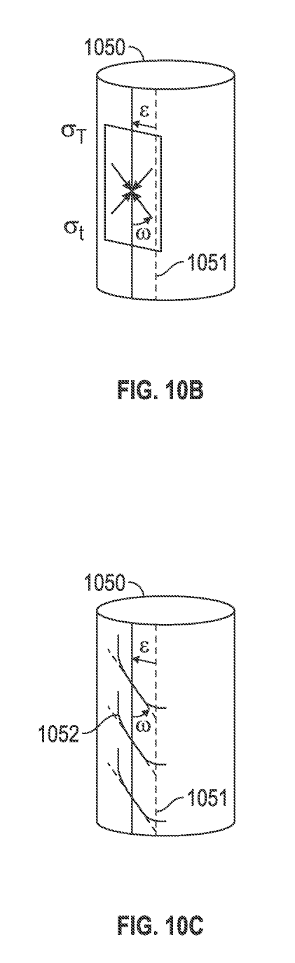

FIG. 10A illustrates a flowchart of a method 1000 for determining an attribute that is related to (e.g., a proxy for) hydraulic fracture tortuosity, in this example, stress misalignment at a borehole-wall, according to an embodiment. The method 1000 may include receiving, as input, a three-dimensional, geo-cellular grid, as at 1002 and well data, as at 1004. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid. The well data may include location, trajectory angles (e.g., dip and azimuth), and/or other information related to a well, whether planned or actual, in the subterranean volume.

The method 1000 may also include calculating a near-well stress field, as at 1006. A near-well stress field may be defined as a stress field that is influenced by the proximity of a well, e.g., as explained above.

The method 1000 may then proceed to determining a fracture orientation at the borehole-wall of the well at the fracture initiation pressure, as at 1008. The fracture orientation may define a fracture plane, and the borehole may define a well axis centrally therein and extending parallel therewith. Accordingly, the method 1000 may proceed to determining a misalignment angle between the fracture plane and the well axis, as at 1010. The fracture initiation pressure may be received as input, e.g., as part of the three-dimensional, geo-cellular model, or may be measured using formation pressure tests, analysis of hydraulic fracturing treatments, or may be calculated according to any suitable technique.

The angle determined may be the angle by which principal tangential stress directions are rotated with respect to the well axis. More specifically, for example, the angle may be the angle at which en-echelon fractures may be expected to form in an open-hole configuration. The angle may thus be defined with respect to the well axis, with values ranging from 0 for longitudinal fractures to about 90 degrees for transverse fractures. Fracture initiation may be calculated assuming that the borehole-wall is impervious or permeable, and, if permeable, support from the mud-cake with a mud-support coefficient ranging from 0 to 1.

FIGS. 10B and 10C illustrate conceptual views of a portion of a well 1050, with two tangential principal stresses, one maximum σ_{T} and one minimum σₜ, according to an embodiment. The angle determined at 1010, i.e., the angle between the fracture plane and the well axis (the well axis is indicated as 1051), which may be the angle by which the principal stress direction is rotated with respect to the well axis 1051, is the angle w indicated in FIG. 10B. As shown, the maximum principal tangential stress direction σ_{T} is rotated, by the angle ω, with respect to the well axis 1051 when the well axis 1051 is not aligned with any far-field principal stress direction. At initiation, the azimuthal position of tensile failure initiation may be located at an angle ε. The angle ε may be determined from north or top-of-hole depending on, for example, whether the well inclination is less or more than 45 degrees, respectively. Such a near-well rotated stress may result in inclined, en-echelon tensile fractures 1052.

Referring again to FIG. 10A, the method 1000 may proceed to determining a difference between the two tangential principal stress magnitudes (e.g., the magnitudes of the two stresses σ_{T} and σₜ, as shown in FIG. 10B), as at 1012. When the magnitudes of the two principal tangential stresses at the borehole-wall are equal, the orientation of the fracture may be undefined. Accordingly, the difference in magnitude may be employed to check whether the fracture orientation (and thus the misalignment and re-orientation angles) is defined, with a larger difference implying a well-defined fracture orientation. Thus, the method 1000 may include determining whether the misalignment and re-orientation angles are undefined, as at 1014. The method 1000 may then, in at least one embodiment, proceed to displaying a representation of the angle between the fracture plan and the well axis and/or the difference between the two tangential principal stress magnitudes along a well trajectory or in three-dimensions, as at 1016. In other embodiments, one or more of these attributes may not be displayed. In either example, the quantitative data may be employed in calculating the completion quality.

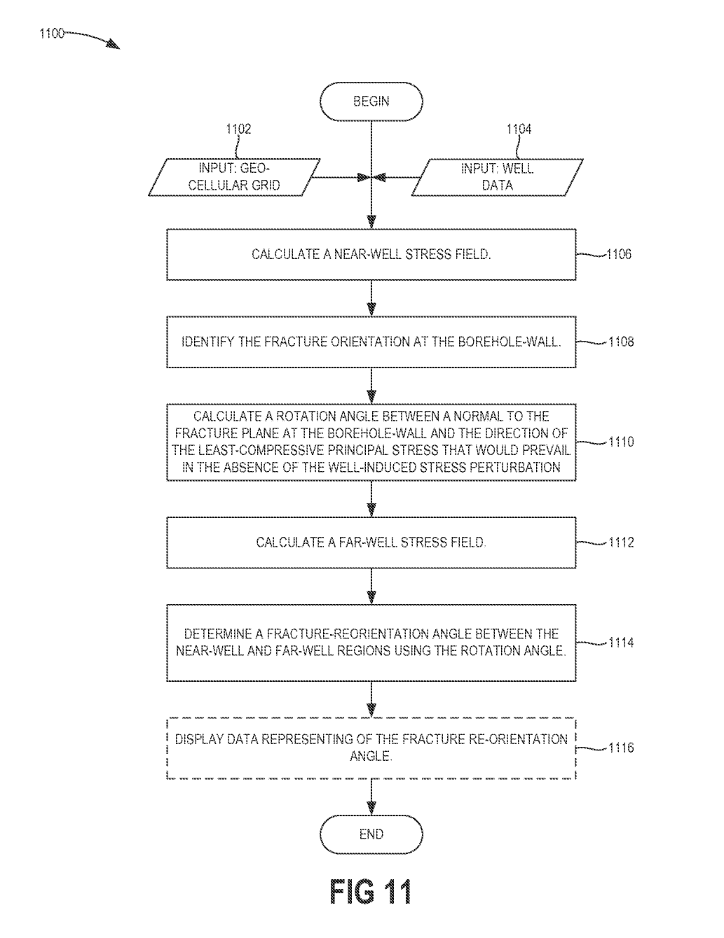

FIG. 11 illustrates a flowchart of a method 1100 for determining a fracture re-orientation, according to an embodiment. The fracture re-orientation may be a hydraulic fracture attribute and may be employed in determining a completion quality. The method 1100 may include receiving a three-dimensional, geo-cellular grid as an input, as at 1102, along with well data, as at 1104. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid. The well data may include location, trajectory angles (e.g., dip and azimuth), and/or other information related to a well, whether planned or actual, in the subterranean volume.

The method 1100 may also include calculating a near-well stress field, as at 1106, e.g. as defined above. With the near-well stress field calculated, the method 110 may include identifying the fracture orientation at the borehole-wall, as at 1108. The method 1100 may include calculating a rotation angle between a normal to the fracture plane at the borehole-wall and the direction of the least-compressive principal stress that would prevail in the absence of the well-induced stress perturbation, as at 1110.

The method 1100 may further include calculating a far-well stress field, as at 1112. The method 1100 may then proceed to determining a fracture reorientation angle between the near-well and far-well regions using the rotation angle, as at 1114. The method 1100 may then, in at least one embodiment, proceed to displaying data representing of the fracture re-orientation angle, e.g., along a well trajectory or in the grid overlaid on the subterranean volume, as at 1116.

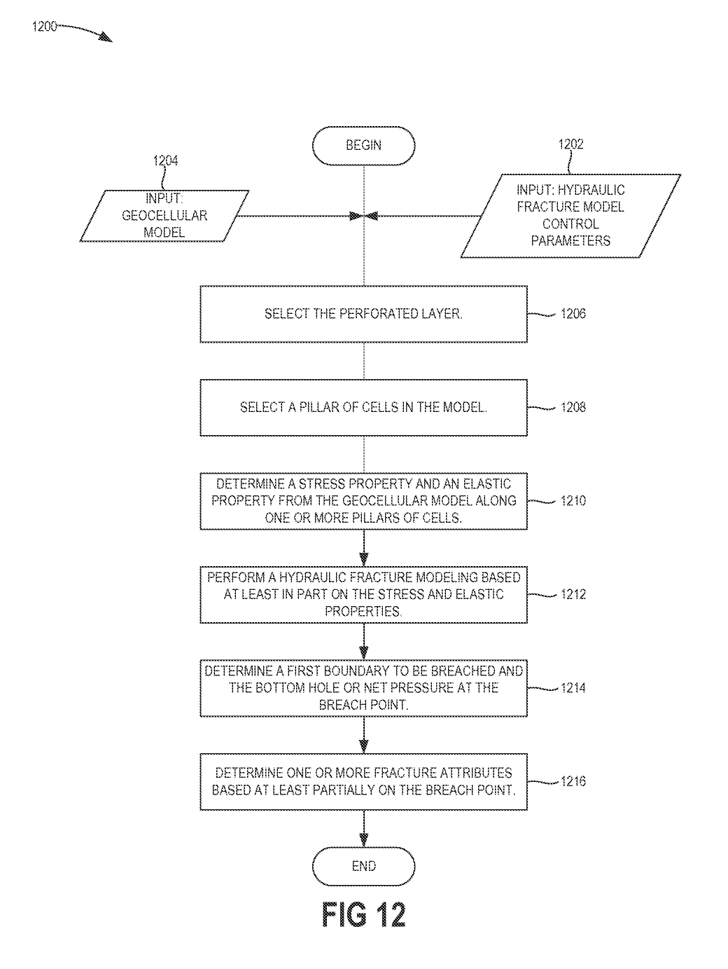

FIG. 12 illustrates a flowchart of a method 1200 for determining fracture geometry such as height and width, according to an embodiment. The method 1200 may include receiving, as input, a three-dimensional, geo-cellular grid, as at 1202 and hydraulic fracture control parameters, as at 1004. The geo-cellular grid may include a plurality of cells that represent discrete regions of the subterranean volume; specifically, in an embodiment, the cells of the grid may include (e.g., as by association in a database, table, etc.) data representing mechanical properties of the medium contained in region of the subterranean volume represented by the cell in the grid. Further, the cells may include or be associated with (e.g., as by a data structure or a table) the magnitudes of the minimum horizontal stress and/or the least compressive principal stress, along with fracture toughness, the Young's modulus, and the Poisson's ratio of the regions of the subterranean model represented by the cells.

The hydraulic fracture control parameters received at 1204 may include top and bottom boundaries of a depth interval of interest, e.g., a reservoir, such as a hydrocarbon reservoir. The parameters may also include a perforated depth interval, which may be provided as an input by a user. The parameters may further include a maximum allowable bottom-hole pressure, which may be constrained by practical equipment and/or tubular capabilities. The parameters may also include maximum upward and downward fracture height growth, which may be received as a multiple of the reservoir thickness that is added above and below the reservoir depth interval. The parameters may further include a selected fracture height growth model, such as equilibrium or modulus-layer. The parameters may also include thresholds for net pressures.

The cells of the grid may be arranged vertically in pillars and horizontally in layers, where the layers may be more than one cell thick. Accordingly, the method 1200 may include selecting the perforated layer (e.g., received as input), as at 1206, and then selecting a pillar of cells, as at 1208. The selected pillar may cover the depth interval and may further span the maximum upward and downward fracture height growth. The method 1200 may then include determining stress and elastic properties of the cells along the pillars in the perforated layer, as at 1210, so as to cover maximum upward and downward fracture height growth from the perforated layer. The data may then be input into a hydraulic fracture modeling application, such as a one-dimensional fracture modeling application. An example of such a hydraulic fracture modeling application is FRACHITE™.

The hydraulic fracturing application may perform a hydraulic fracturing simulation. The results of the simulation may be loaded into the three-dimensional, geo-cellular model, as at 1212. Such results may include bottom-hole or net pressure at the perforated layer, fracture top and bottom positions, average fracture width, average stress along the fracture at the well, etc., and may be as a function of fracture height. Profiles of fracture width along the fracture may also be calculated.

The method 1200 may then determine a first boundary to be breached and the bottom-hole or net pressure at the breach point, as at 1214. The method 1200 may also include determining one or more fracture attributes based at least partially on the breach point and/or other fracture properties, as at 1216. For example, the method 1200 may include determining the net pressure at the breach point, and/or an average hydraulic fracture height and reservoir thickness to fracture height ratio, e.g., at user-defined values of net pressure and at the breach point. Further, the method 1200 may include determining an average hydraulic fracture height above the perforated layer and ratio between the height and the thickness of the reservoir above the perforated layer, e.g., at user-defined values of net pressure and at the breach point. The method 1200 may also include determining an average hydraulic fracture height below the perforated layer and ratio between this height and the thickness of the reservoir below the perforated layer, e.g., at user-defined values of net pressure and at the breach point, and/or an average hydraulic fracture width, e.g., at user-defined values of net pressure and at the breach point. The method 1200 may also include determining a pressure-height derivative at the breach point, and/or a maximum bottom-hole or net pressure reached.

In addition, in some embodiments, the method 1200 may also include determining a status of the simulation (e.g., successful propagation or early termination after fracture initiation in a high stress layer and full fracture closure).

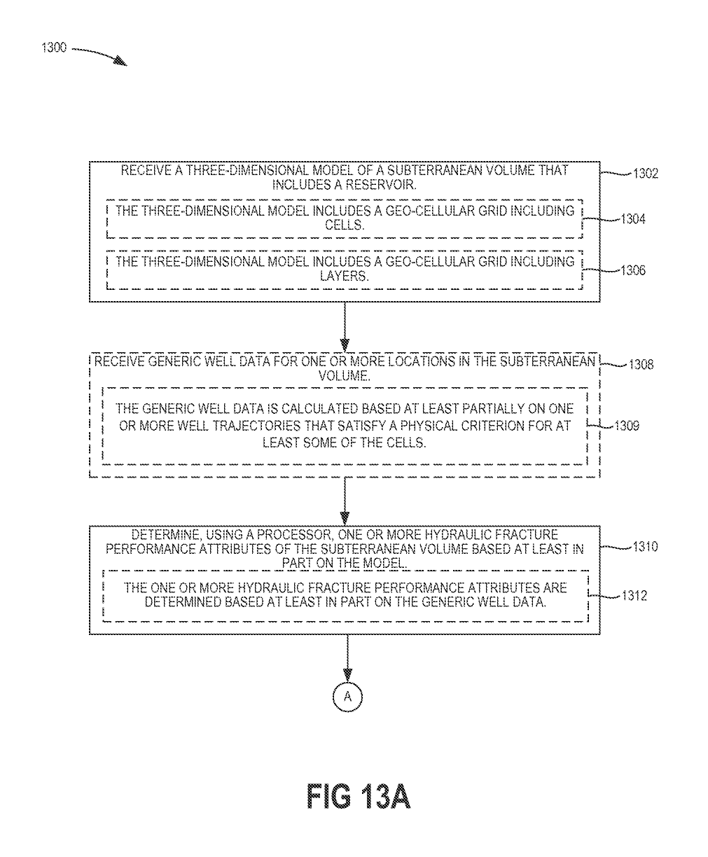

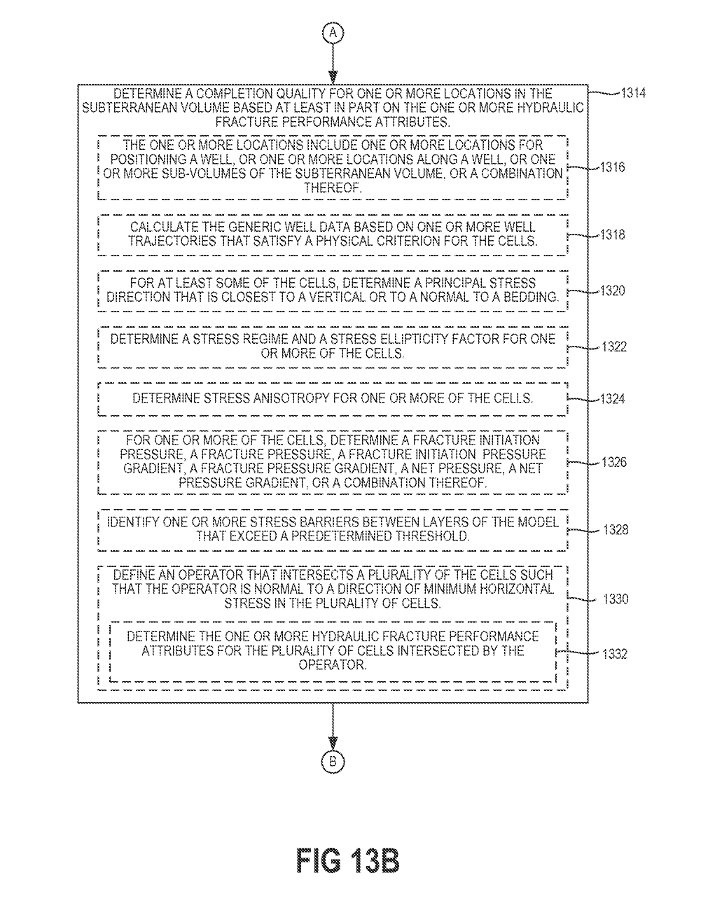

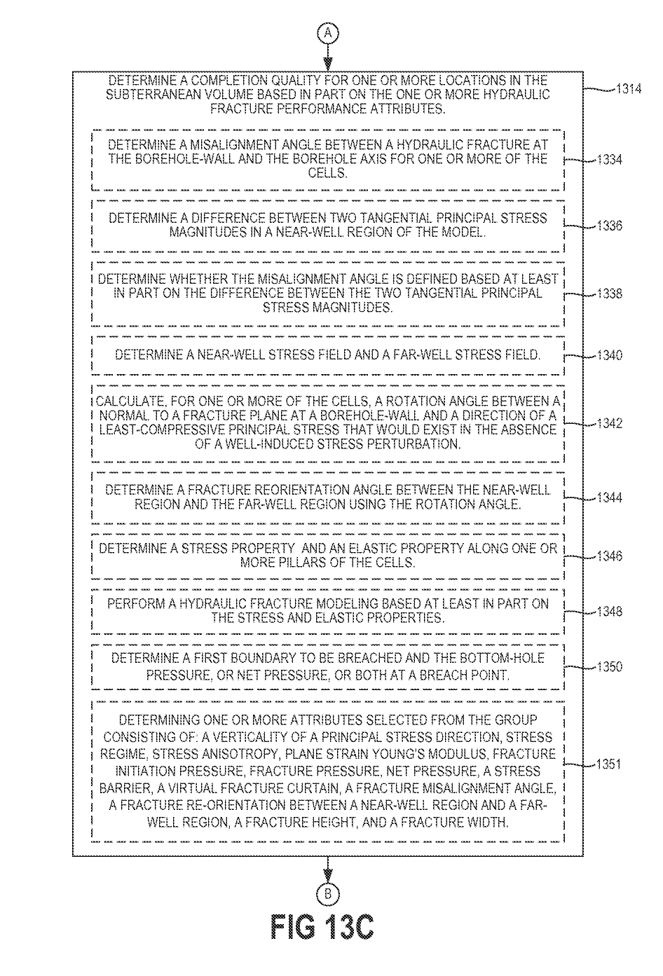

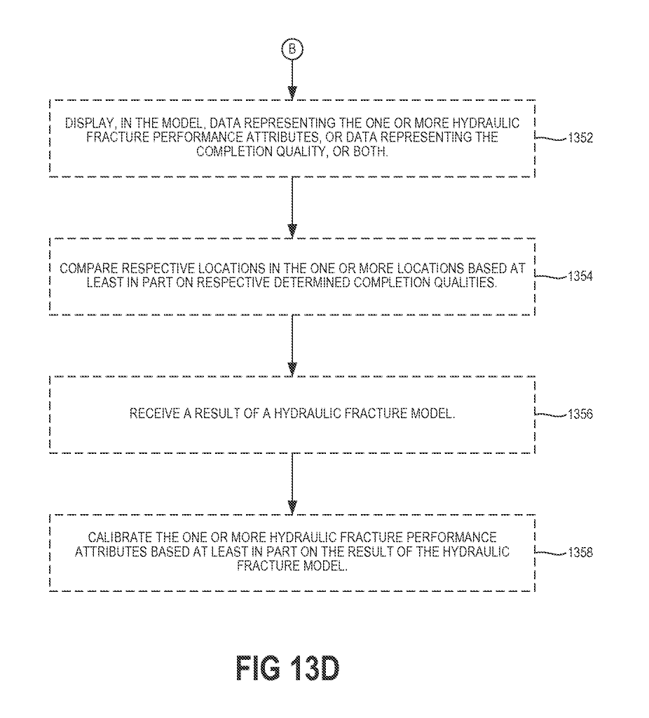

FIGS. 13A-D illustrate a flowchart of a method 1300 for processing geomechanical data, according to one or more embodiments. The method 1300 may include receiving a three-dimensional model of a subterranean volume that includes a reservoir, as at 1302 (e.g., 202, FIG. 2; receiving a three-dimensional mechanical earth model). In an embodiment, the three-dimensional model includes a geo-cellular grid including cells, as at 1304 (e.g., FIG. 3, 304; the grid includes cells). In an embodiment, the three-dimensional model includes a geocellular grid including layers, as at 1306 (e.g., FIG. 8A, 804, the grid includes layers that can be selected).

In an embodiment, the method 1300 may also include receiving generic well data for one or more locations in the subterranean volume, as at 1308 (e.g., FIG. 10A, 1004; receiving well data, the well data may be generic). In an embodiment, the generic well data may be calculated based at least partially one or more well trajectories that satisfy a physical criterion for one or more of the cells, as at 1309.

In an embodiment, the method 1300 may include determining, using a processor, one or more hydraulic fracture performance attributes, of the subterranean volume based at least in part on the model, as at 1310. In an embodiment, the one or more hydraulic performance attributes are determined based at least in part on the generic well data, as at 1312 (e.g., 204, FIG. 2; determining one or more hydraulic fracture performance attributes, which may be determined based on well data).

Referring now to FIG. 13B, the method 1300 may further include determining a completion quality for one or more locations in the subterranean volume based at least in part on the one or more hydraulic fracture performance attributes, as at 1314 (e.g., FIG. 2, 210; determining the completion quality based on the hydraulic fracture performance attributes). In an embodiment, the one or more locations include one or more locations for positioning a well, or one or more locations along a well, or one or more sub-volumes of the subterranean volume, or a combination thereof, 1316. In an embodiment, determining at 1314 may include, for one or more of the cells, determining a principal stress direction that is closest to a vertical or to a normal to a bedding, as at 1320 (e.g., FIG. 3, 310, selecting the stress direction that forms the smallest angle with respect to vertical). In an embodiment, determining at 1314 may include determining a stress regime and a stress ellipticity factor for one or more of the cells (e.g., FIG. 4, 415; determining a stress regime and a stress ellipticity based at least in part on the Q-factor), as at 1322. In an embodiment, determining at 1314 may include determining a stress anisotropy for one or more of the cells, as at 1324 (e.g., FIG. 5, 512; determining a stress anisotropy attribute value). In an embodiment, determining at 1314 may include, for one or more of the cells, determining a fracture initiation pressure, a fracture pressure, a fracture initiation pressure gradient, a fracture pressure gradient, a net pressure, a net pressure gradient, or a combination thereof, as at 1326 (e.g., FIGS. 7, 712, 716, 718, and 719; determining the fracture initiation pressure, fracture pressure, fracture initiation pressure gradient, fracture pressure gradient, and net pressure gradient).

In an embodiment, determining at 1314 may include identifying one or more stress barriers between layers of the model that exceed a predetermined threshold, as at 1326 (e.g., FIG. 8A, 818; identifying stress barriers that exceed a threshold). In an embodiment, determining at 1314 defining an operator that intersects a plurality of the cells such that the operator is normal to a direction of minimum horizontal stress in the plurality of cells, as at 1330 (e.g., FIG. 9, 906; defining the operator in the grid from an initiation point, such that the operator is normal to a direction of minimum horizontal stress of the grid cells). Determining at 1314 may also include determining the one or more hydraulic fracture performance attributes for the plurality of cells intersected by the operator, as at 1332 (e.g., FIG. 9, 910; determining one or more hydraulic fracture performance attributes of the subset of the cells intersected by the operator).

Referring now to FIG. 13C, in an embodiment, determining at 1314 may include determining a misalignment angle between a hydraulic fracture at the borehole-wall and the well axis for one or more of the cells, as at 1334 (e.g., FIG. 10A, 1010; determining a misalignment angle between a fracture plane and the well axis). In an embodiment, determining at 1314 may include determining a difference between two tangential principal stress magnitudes in a near-well region of the model, as at 1336 (e.g., FIG. 10A, 1012; determining a difference between two tangential principal stress magnitudes). In an embodiment, determining at 1314 may also include determining whether the misalignment angle is defined based at least in part on the difference between the two tangential principal stress magnitudes, as at 1338 (e.g., FIG. 10A, 1014; determining whether the fracture orientation angle is defined based at least partially on the difference).

In an embodiment, determining at 1314 may include determining a near-well stress field and a far-well stress field, as at 1340 (e.g., FIG. 11, 1106; calculate a near-well stress field). In an embodiment, determining at 1314 may include calculating, for one or more of the cells, a rotation angle between a normal to a fracture plane at a borehole-wall, and a direction of a least-compressive principal stress that would exist in the absence of a well-induced stress perturbation, as at 1342 (e.g., FIG. 11, 1110; calculating a rotation angle between a normal to the fracture plane at the borehole-wall and the direction of the least-compressive principal stress that would prevail in the absence of the well-induced stress perturbation). Determining at 1314 may also include determining a fracture reorientation angle between the near-well region and the far well-region using the rotation angle, as at 1344 (e.g., FIG. 11, 1114; determining a fracture-reorientation angle between the near-well and far-well regions using the rotation angle).

In an embodiment, determining at 1314 may include determining a stress property and an elastic property along one or more pillars of the cells, as at 1346 (e.g., FIG. 12, 1210; determining a stress property and an elastic property from the geocellular model along one or more pillars of cells). Determining at 1314 may also include performing a hydraulic fracture modeling based at least in part on the stress and elastic properties, as at 1348 (e.g., FIG. 12, 1212; performing a hydraulic fracture modeling based at least in part on the stress and elastic properties). In an embodiment, determining at 1314 may include determining a first boundary to be breached and the bottom-hole pressure, or net pressure, or both at a breach point, as at 1350 (e.g., FIG. 12, 1214; determining a first boundary to be breached and the bottom hole or net pressure at the breach point).

In an embodiment, determining at 1314 may include determining one or more attributes selected from the group consisting of: a verticality of a principal stress direction (e.g., 300, FIG. 3A; a method for determining verticality of a principal stress direction), a stress regime (e.g., 400, FIG. 4; a method for determining stress regime), a stress anisotropy (e.g., 500, FIG. 5; a method for determining stress anisotropy), a plane strain Young's modulus (e.g., 600, FIG. 6; a method for determining plane strain Young's moduli), a fracture initiation pressure, a fracture pressure, and/or a net pressure (e.g., 700, FIG. 7; a method for determining fracture initiation pressure, fracture pressure, and/or net pressure), a stress barrier (e.g., 800, FIG. 8A; a method for determining a stress barrier), a virtual fracture curtain (e.g., 900, FIG. 9, a method for determining a virtual fracture curtain), a fracture misalignment angle (e.g., 1000, FIG. 10; a method for determining a fracture misalignment angle), a fracture re-orientation between a near-well region and a far-well region (e.g., 1100, FIG. 11; a method for determining a fracture-orientation between a near-well region and a far-well region), a fracture height, and a fracture width, as at 1351 (e.g., 1200, FIG. 12; a method for determining fracture geometry such as height and width).

Proceeding to FIG. 13D, the method 1300 may, in an embodiment, include displaying, in the model, data representing the one or more hydraulic fracture performance attributes, or data representing the completion quality, or both, as at 1352 (e.g., 212, FIG. 2, displaying the completion quality; 316, FIG. 3A, displaying the data representing the angles and/or locations, which is the attribute in this example). In an embodiment, the method 1300 may also include comparing respective locations in the one or more locations based at least in part on respective determined completion qualities, as at 1354 (e.g., 108, FIG. 1, comparing the locations based on the respective completion qualities thereof). In an embodiment, the method 1300 may receiving a result of a hydraulic fracture model, as at 1356 (e.g., 206, FIG. 2, a hydraulic fracture model is inputted). In an embodiment, the method 1300 may include calibrating the one or more hydraulic fracture performance attributes based at least in part on the result of the hydraulic fracture model, as at 1358 (e.g., 208, FIG. 2, calibrating the one or more hydraulic performance attributes based on the hydraulic fracture model).

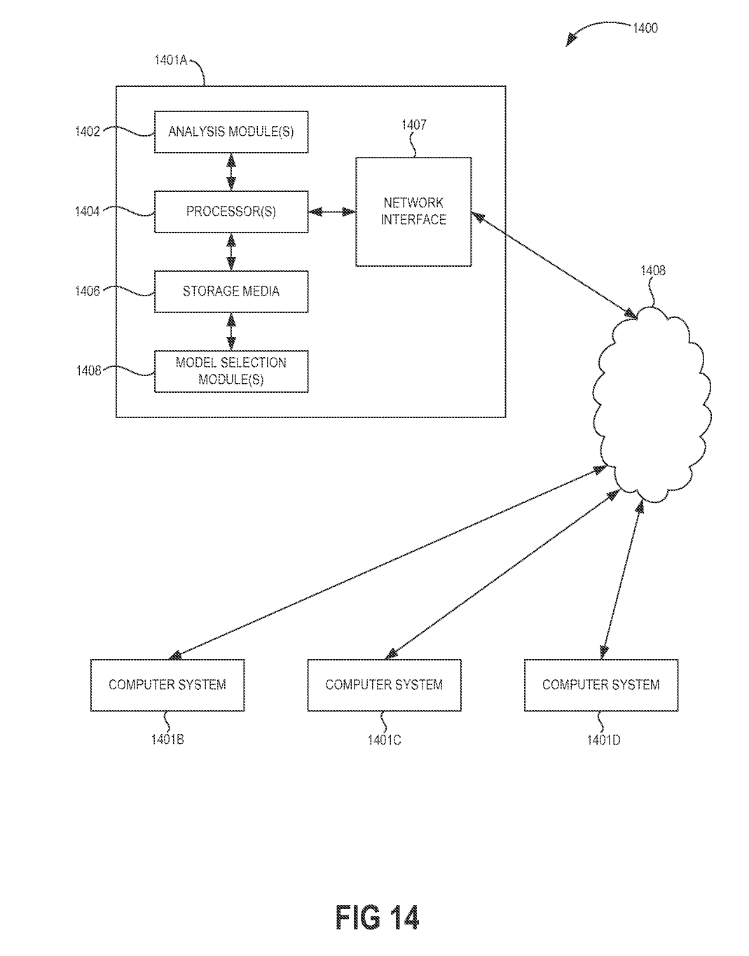

In some embodiments, the methods 100-1300 may be executed by a computing system. FIG. 14 illustrates an example of such a computing system 1400, in accordance with some embodiments. The computing system 1400 may include a computer or computer system 1401A, which may be an individual computer system 1401A or an arrangement of distributed computer systems. The computer system 1401A includes one or more analysis modules 1402 that are configured to perform various tasks according to some embodiments, such as one or more methods disclosed herein (e.g., methods 100-1300, and/or combinations and/or variations thereof). To perform these various tasks, the analysis module 1402 executes independently, or in coordination with, one or more processors 1404, which is (or are) connected to one or more storage media 1406A. The processor(s) 1404 is (or are) also connected to a network interface 1407 to allow the computer system 1401A to communicate over a data network 1408 with one or more additional computer systems and/or computing systems, such as 1401B, 1401C, and/or 1401D (note that computer systems 1401B, 1401C and/or 1401D may or may not share the same architecture as computer system 1401A, and may be located in different physical locations, e.g., computer systems 1401A and 1401B may be located in a processing facility, while in communication with one or more computer systems such as 1401C and/or 1401D that are located in one or more data centers, and/or located in varying countries on different continents).

A processor can include a microprocessor, microcontroller, processor module or subsystem, programmable integrated circuit, programmable gate array, or another control or computing device.

The storage media 1406A can be implemented as one or more computer-readable or machine-readable storage media. Note that while in the example embodiment of FIG. 14 storage media 1406A is depicted as within computer system 1401A, in some embodiments, storage media 1406A may be distributed within and/or across multiple internal and/or external enclosures of computing system 1401A and/or additional computing systems. Storage media 1406A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1400 contains one or more completion quality determination module(s) 1408. In the example of computing system 1400, computer system 1401A includes the completion quality determination module 1408. In some embodiments, a single completion quality determination module may be used to perform some or all aspects of one or more embodiments of the methods 100-1300. In alternate embodiments, a plurality of completion quality determination modules may be used to perform some or all aspects of methods 100-1200.

It should be appreciated that computing system 1400 is only one example of a computing system, and that computing system 1400 may have more or fewer components than shown, may combine additional components not depicted in the example embodiment of FIG. 14, and/or computing system 1400 may have a different configuration or arrangement of the components depicted in FIG. 14. The various components shown in FIG. 14 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

It is important to recognize that geologic interpretations, models and/or other interpretation aids may be refined in an iterative fashion; this concept is applicable to methods 100-1200 as discussed herein. This can include use of feedback loops executed on an algorithmic basis, such as at a computing device (e.g., computing system 1400, FIG. 14), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods 100-1300 are illustrate and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for processing geomechanical data, comprising:
receiving a three-dimensional model of a subterranean volume that includes a reservoir;
determining, using a processor, one or more hydraulic fracture performance attributes of the subterranean volume based in part on the model; and
determining a completion quality for one or more locations in the subterranean volume based at least in part on the one or more hydraulic fracture performance attributes.

2. The method of claim 1, further comprising displaying data representing the one or more hydraulic fracture performance attributes in the model, displaying data representing the completion quality in the model, or both.

3. The method of claim 1, wherein the one or more locations comprise one or more locations for positioning a well, or one or more locations along a well, or one or more sub-volumes in the subterranean domain, or a combination thereof, the method further comprising comparing respective locations in the one or more locations based at least in part on respective determined completion qualities.

4. The method of claim 1, further comprising receiving generic well data for a plurality of locations in the subterranean volume, wherein determining the one or more hydraulic fracture performance attributes comprises using the generic well data.

5. The method of claim 4, wherein the model comprises a geo-cellular grid comprising cells, the method further comprising calculating the generic well data based at least partially on one or more well trajectories that satisfy a physical criterion for one or more of the cells.

6. The method of claim 1, wherein the three-dimensional model comprises a geo-cellular grid comprising cells, and wherein determining the one or more hydraulic fracture performance attributes comprises, for one or more of the cells, determining a principal stress direction that is closest to a vertical or to a normal to a bedding.

7. The method of claim 1, wherein the three-dimensional model comprises a geo-cellular grid comprising cells, and wherein determining the one or more hydraulic fracture performance attributes comprises determining a stress regime and a stress ellipticity factor for one or more of the cells.

8. The method of claim 1, wherein the three-dimensional model comprises a geo-cellular grid comprising cells, and wherein determining the one or more hydraulic fracture performance attributes comprises determining a stress anisotropy for one or more of the cells.

9. The method of claim 1, wherein the three-dimensional model comprises a geo-cellular grid comprising cells, and wherein determining the one or more hydraulic fracture performance attributes comprises, for one or more of the cells, determining a fracture initiation pressure, a fracture pressure, a fracture initiation pressure gradient, a fracture pressure gradient, a net pressure, a net pressure gradient, or a combination thereof.

10. The method of claim 1, wherein the three-dimensional model comprises a geo-cellular grid comprising layers, and wherein determining the one or more hydraulic fracture performance attributes comprises identifying one or more stress barriers between layers of the model that exceed a predetermined threshold.

11. The method of claim 1, wherein the three-dimensional model comprises a geo-cellular grid comprising cells, and wherein determining the one or more hydraulic fracture performance attributes comprises:
defining an operator that intersects a plurality of the cells such that the operator is normal to a direction of minimum horizontal stress in the plurality of cells; and
determining the one or more hydraulic fracture performance attributes for the plurality of cells intersected by the operator.

12. The method of claim 1, wherein the three-dimensional model comprises a geo-cellular grid comprising cells, and wherein determining the one or more hydraulic fracture performance attributes comprises:
determining a misalignment angle between a hydraulic fracture at the borehole-wall and the well axis for one or more of the cells;
determining a difference between two tangential principal stress magnitudes in a near-well region of the model; and
determining whether the misalignment angle is defined based at least in part on the difference between the two tangential principal stress magnitudes.

13. The method of claim 1, wherein the three-dimensional model comprises a geo-cellular grid comprising cells, and wherein determining the one or more hydraulic fracture performance attributes comprises:
determining a near-well stress field and a far-well stress field;
calculating, for one or more of the cells, a rotation angle between a normal to a fracture plane at a borehole-wall and a direction of a least-compressive principal stress that would exist in the absence of a well-induced stress perturbation; and
determining a fracture reorientation angle between the near-well and far-well regions using the rotation angle.

14. The method of claim 1, wherein the three-dimensional model comprises a geo-cellular grid comprising cells, and wherein determining the one or more hydraulic fracture performance attributes comprises:
determining a stress property and an elastic property along one or more pillars of the cells;
performing a hydraulic fracture modeling based at least in part on the stress and elastic properties; and
determining a first boundary to be breached and the bottom-hole pressure, or net pressure, or both at a breach point.

15. The method of claim 1, further comprising:
receiving a result of a hydraulic fracture model; and
calibrating the one or more hydraulic fracture performance attributes based at least in part on the result of the hydraulic fracture model.

16. The method of claim 1, wherein determining the one or more hydraulic fracture performance attributes comprises determining one or more attributes selected from the group consisting of: a verticality of a principal stress direction, stress regime, stress anisotropy, plane strain Young's modulus, fracture initiation pressure, fracture pressure, net pressure, a stress barrier, a virtual fracture curtain, a fracture misalignment angle, a fracture re-orientation between a near-well region and a far-well region, a fracture height, and a fracture width.

17. A computer system, comprising:
one or more processors; and
a memory system comprising one or more non-transitory computer-readable media storing instructions that, when executed by at least one of the one or more processors, cause the computer system to perform operations, the operations comprising:
receiving a three-dimensional model of a subterranean volume that includes a reservoir;
determining, using a processor, one or more hydraulic fracture performance attributes of the subterranean volume based in part on the model; and
determining a completion quality for one or more locations in the subterranean volume based at least in part on the one or more hydraulic fracture performance attributes.

18. The computer system of claim 17, wherein determining the one or more hydraulic fracture performance attributes comprises determining one or more attributes selected from the group consisting of: a verticality of a principal stress direction, stress regime, stress anisotropy, plane strain Young's modulus, fracture initiation pressure, fracture pressure, net pressure, a stress barrier, a virtual fracture curtain, a fracture misalignment angle, a fracture re-orientation between a near-well region and a far-well region, a fracture height, and a fracture width.
